(19) United States
(12) Patent Application Publication
(10) Pub. No.: US 2024/0064879 A1
(43) Pub. Date: Feb. 22, 2024

(54) COOKING APPLIANCE

(71) Applicant: SAMSUNG ELECTRONICS CO., LTD., Suwon-si (KR)

(72) Inventor: Jiho JEONG, Suwon-si (KR)

(73) Assignee: SAMSUNG ELECTRONICS CO., LTD., Suwon-si (KR)

(21) Appl. No.: 18/237,193

(22) Filed: Aug. 23, 2023

Related U.S. Application Data
(63) Continuation of application No. PCT/KR2022/003936, filed on Mar. 22, 2022.

(30) Foreign Application Priority Data
Mar. 31, 2021 (KR) 10-2021-0042349
Jul. 5, 2021 (KR) 10-2021-0087802

(51) Int. Cl. H05B 6/64

(52) U.S. Cl. CPC H05B 6/642; H05B 6/6444

(57) ABSTRACT

A cooking apparatus including an inner housing forming a cooking room; an outer housing, with a cooling space between the inner housing and the outer housing; a cooling fan in the cooling space at a lower rear side of the cooking room, and configured to suction air from outside of the cooking apparatus and to discharge the suctioned air forward; a first duct configured to guide a portion of the air discharged by the cooling fan upward to cool a first electronic component in the cooling space and to guide a remaining portion of the air discharged by the cooling fan forward to cool a second electronic component disposed in the cooling space; and a second duct configured to guide a portion of the air guided forward by the first duct into an interior of the cooking room.

### CROSS-REFERENCE TO RELATED APPLICATIONS

This application is a continuation of International Application PCT/KR2022/003936, filed Mar. 22, 2022, which is incorporated herein by reference in its entirety, and claims foreign priority to Korean application 10-2021-0042349, filed Mar. 31, 2021, and Korean application 10-2021-0087802, filed Jul. 5, 2021, and which are incorporated herein by reference in their entireties.

### BACKGROUND

### 1. Field

The present disclosure relates to a cooking apparatus, and more particularly to a cooking apparatus comprising a flow path structure for cooling electronic components.

### 2. Description of Related Art

In general, a cooking apparatus is a device for heating and cooking a cooking object, such as food. Specifically, it can perform various functions related to cooking, such as heating, defrosting, drying, and sterilizing the cooking object. Such cooking apparatus includes, for example, an oven, such as a gas oven or an electric oven, a microwave heating device (hereinafter referred to as a microwave), a gas range, an electric range, a gas grill, or an electric grill.

In general, an oven is a device that cooks food by transferring heat directly to the food through a heating source that generates heat such as a heater or by heating the inside of the cooking room, and a microwave oven is a device that cooks food by intermolecular friction heat generated by disturbing the molecular arrangement of food using high frequency as a heating source.

A cooking apparatus requires a number of electronic components to function. The electronic components generate heat when they operate. When heat is generated at a certain temperature or higher, the electronic components may not perform the intended function. Therefore, a structure is needed that acts to cool the elevated temperature of the electronic components.

### SUMMARY

According to an embodiment of the present disclosure, a cooking apparatus includes an inner housing forming a cooking room having a front that is open, an outer housing on an outer side of the inner housing, with a cooling space being between the inner housing and the outer housing, a door configured to open and close the open front of the cooking room, a cooling fan in the cooling space at a lower rear side of the cooking room, the cooling fan configured to suction air from outside of the cooking apparatus and to discharge the suctioned air forward in the cooking apparatus, a first duct configured to guide a portion of the air discharged by the cooling fan upward to cool a first electronic component in the cooling space and to guide a remaining portion of the air discharged by the cooling fan forward to cool a second electronic component disposed in the cooling space, and a second duct configured to guide a portion of the air guided forward by the first duct into an interior of the cooking room.

According to an embodiment of the present disclosure, the cooking apparatus may further include a heater on the top of the cooking room to heat the cooking room, wherein the first electronic component is adjacent to the heater.

According to an embodiment of the present disclosure, the first electronic component may include a lamp on an outer surface of the cooking room to illuminate an interior of the cooking room.

According to an embodiment of the present disclosure, the second electronic component may include a magnetron configured to generate a high frequency to heat a cooking item placed in the cooking room.

According to an embodiment of the present disclosure, the cooking apparatus may further include a fan box enclosing the cooling fan and configured to guide the air discharged by the cooling fan to the first duct.

According to an embodiment of the present disclosure, the first duct may include a first duct part having an inlet facing the cooling fan so that the air discharged by the cooling fan is introduced into the first duct through the inlet, and a second duct part coupled to the first duct part and extending toward the first electronic component to guide air to the first electronic component.

According to an embodiment of the present disclosure, the first duct part may include a duct first area coupled to the second duct part, and configured to guide a portion of the air introduced into the first duct part to the first electronic component, and a duct second area adjacent to the duct first area, and configured to guide a portion of the air introduced into the first duct part into the cooling space.

According to an embodiment of the present disclosure, a cross-sectional area ratio of the duct first area and the duct second area is equal to 20˜30:80˜70.

According to an embodiment of the present disclosure, the second duct includes an outlet through which air guided by the second duct is released, the outlet is coupled to a side of the inner housing, and a cooking room inlet is on the side of the inner housing so as to be positioned to receive the air released through the outlet.

According to an embodiment of the present disclosure, the second duct including a damper rotatably coupled inside the second duct, and the damper is configured to allow or block air flow from the second duct into the cooking room interior.

According to an embodiment of the present disclosure, the cooking apparatus may include a heater on a top surface of the cooking room to heat the cooking room, the first electronic component includes a magnetron configured to generate a high frequency, and the damper is configured to allow air from the second duct to flow into interior of the cooking room when the heater is not operating and the magnetron is operating.

According to an embodiment of the present disclosure, the second duct may include a duct body having an inlet at a front of the first duct so that air discharged by the first duct is introduced into the duct body through the inlet of the duct body, and a duct extending portion coupled to the duct body, and extending upward toward the cooking room.

According to an embodiment of the present disclosure the outer housing has a hole configured to allow air to escape through the hole when air flow from the second duct is blocked by the damper.

According to an embodiment of the present disclosure, an air outflowing from the first duct flows to the second electronic component and into the second duct.

According to an embodiment of the present disclosure, the cooking apparatus may further include another cooling fan at a lateral side of the cooling fan in the cooling space at the lower rear side of the cooking room to cool the third electronic component, wherein the cooling fan and the another cooling fan are driven by a single fan motor.

According to an embodiment of the present disclosure, a cooking apparatus may include an inner housing forming a cooking room with an open front surface, an outer housing provided on an outer side of the inner housing, a door for opening and closing the open front of the cooking room, a cooling space formed between the inner housing and the outer housing, a first cooling fan arranged in the cooling space at the lower rear of the cooking room, and which draws in air and discharges the air forward, a duct guiding a portion of the air discharged from the first cooling fan upwardly to cool a first electronic component disposed in the cooling space, and guiding a remaining portion of the air discharged from the first cooling fan forwardly to cool a second electronic component disposed in the cooling space and a second cooling fan disposed in the cooling space at the rear of the lower portion of the cooking room to be positioned laterally of the first cooling fan to cool a third electronic component, the first cooling fan and the second cooling fan are driven by one fan motor.

According to an embodiment of the present disclosure, the cooking apparatus may further include a heater arranged on top of the cooking room to heat the cooking room, the first electronic component is positioned adjacent to the heating source, the first electronic component further comprises a lamp arranged on an exterior surface of the cooking room to illuminate the interior of the cooking room, the second electronic component comprises a magnetron that generates high frequencies to heat a food item disposed in the cooking room.

According to an embodiment of the present disclosure, the duct may include a first duct part having an inlet positioned toward the cooling fan, into which air discharged from the cooling fan flows and a second duct part coupled to the first duct part, extending toward the first electronic component, and guiding air to the first electronic component, wherein the first duct part includes a duct first area coupled to the second duct part, and guiding a portion of the air drawn into the first duct part into the second duct part and a duct second area located adjacent to the duct first area, and guiding a portion of the air introduced into the first duct part into the cooling space, wherein air outflowing from the duct second area flows toward the second electronic.

According to an embodiment of the present disclosure, a cooking apparatus may include an inner housing forming a cooking room with an open front surface, an outer housing provided on an outer side of the inner housing, a door for opening and closing the open front of the cooking room, a cooling space formed between the inner housing and the outer housing, a first cooling fan arranged in the cooling space at the lower rear of the cooking room, and which draws in air and discharges it forwardly, a duct for directing a portion of the air discharged from the first cooling fan into the interior of the cooking room and a second cooling fan disposed in the cooling space in the lower rear of the cooking room to be positioned laterally of the first cooling fan to cool an electronic component, wherein the first cooling fan and the second cooling fan are driven by a single fan motor.

According to an embodiment of the present disclosure, the duct may include an outlet through which air escapes, the outlet is coupled to a side of the inner housing, a cooking room inlet corresponding to the outlet is formed on a side of the inner housing, the duct includes a damper rotatably coupled to an interior of the duct, the damper allows or blocks the flow of air from the duct to the interior of the cooking room.

### BRIEF DESCRIPTION OF THE DRAWINGS

Aspects, features, and advantages of certain embodiments of the present disclosure will be more apparent from the following description taken in conjunction with the accompanying drawings, in which:

FIG. 1 is a perspective view illustrating an exterior view of a cooking apparatus according to one embodiment of the present disclosure.

FIG. 2 is a perspective view illustrating a portion of the configuration inside the cooking apparatus shown in FIG. 1.

FIG. 3 is a cross-sectional view of the cooking apparatus of FIG. 1 cut along a plane parallel to a front panel of an outer housing.

FIG. 4 is a perspective view of the cooking apparatus of FIG. 1 with a housing cover removed, which is viewed from another side.

FIG. 5 is a perspective view of the cooking apparatus of FIG. 1 with an outer housing and an inner housing provided transparent to show the electronic components.

FIG. 6 is an exploded perspective view centered on a first duct and a second duct of the cooking apparatus of FIG. 4.

FIG. 7 is a perspective view of the rear of the cooking apparatus of FIG. 1.

FIG. 8 is an electronic component representation of the cooking apparatus of FIG. 1, viewed from the top.

FIG. 9 is an electronic component representation of the cooking apparatus of FIG. 1, viewed from the left.

FIG. 10 is an electronic component representation of the cooking apparatus of FIG. 1, viewed from the front.

FIG. 11 is a perspective view centered on a first duct, a second duct, and a second electronic component of FIG. 4.

FIG. 12 is a view of the second duct from top to bottom, with the damper open.

FIG. 13 is a view of the second duct from top to bottom, with the damper closed.

FIG. 14 is an exploded perspective view centered on the first duct of the cooking apparatus of FIG. 4.

FIG. 15 is a cross-sectional view of section AA′ centered on a first duct part and a cooling fan shown in FIG. 11.

FIG. 16 is a graph showing the results of the experiment for H1 and H2.

### DETAILED DESCRIPTION

The embodiments described herein and the configurations illustrated in the drawings are merely preferred examples of the disclosed invention, and there are many variations that may be substituted for the embodiments and drawings described herein at the time of filing of this application.

In addition, identical reference numerals or symbols in each drawing of this specification designate parts or components that perform substantially the same function.

Further, the terminology used herein is intended to describe embodiments and is not intended to limit and/or define the disclosed invention. The singular expression includes the plural unless the context clearly indicates otherwise. In this specification, the terms “includes” or “has” and the like are intended to designate the presence of the features, numbers, steps, actions, components, parts, or combinations thereof described, and do not preclude the possibility of the presence or addition of one or more other features, numbers, steps, actions, components, parts, or combinations thereof.

Further, as used herein, ordinal terms such as “first,” “second,” and the like may be used to describe various components, but the components are not limited by such terms, and such terms are used only to distinguish one component from another. For example, without departing from the scope of the present invention, a first component may be named a second component, and similarly, a second component may be named a first component. The term “and/or” includes a combination of a plurality of related recited items or any one of a plurality of related recited items.

On the other hand, as used in the following description, the terms “up and down,” “bottom,” and “front and rear” are defined with reference to the drawings, and the shape and position of each component are not limited by these terms.

The cooking apparatus according to one embodiment of the present invention is described using a microwave oven as an example. However, without limitation, the cooking apparatus according to one embodiment of the present invention may also be applied to other cooking apparatus, such as an oven.

An aspect according to various embodiments of the present disclosure provides a flow path structure for guiding air to cool an electronic component.

Furthermore, according to various embodiments of the present disclosure, an electronic component can be cooled efficiently without the need for a separate cooling fan.

According to various embodiments of the present disclosure, a flow path structure is provided for guiding air to remove moisture from an interior door of a cooking room.

Moreover, according to various embodiments of the present disclosure, a flow path structure is provided to guide air to a door side, so that moisture on the door can be efficiently removed.

Embodiments of the present invention will be described in detail below.

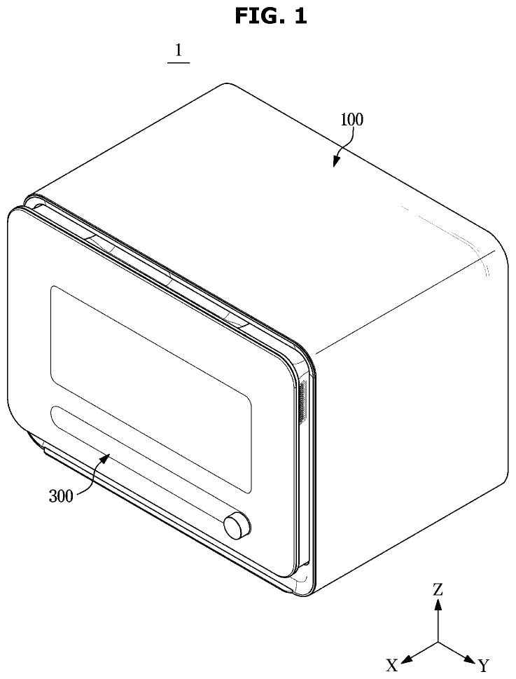

FIG. 1 is a perspective view illustrating an exterior view of a cooking apparatus 1 according to one embodiment of the present disclosure.

The cooking apparatus 1 may include an outer housing 100 forming an exterior, and a door 300 rotatably coupled to the outer housing 100.

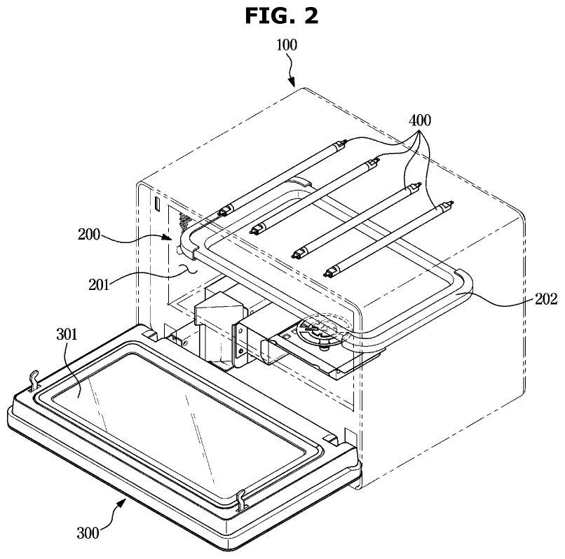

FIG. 2 is a perspective view illustrating a portion of a configuration inside the cooking apparatus 1 shown in FIG. 1.

The cooking apparatus 1 may include an inner housing 200 disposed inside the outer housing 100 and forming a cooking room 201.

The outer housing 100 and the inner housing 200 may be arranged to open toward the front of the cooking apparatus 1.

A user may place a food item into the cooking room 201 or remove a food item from the cooking room 201 through an opening in the inner housing 200.

The cooking room 201 may be arranged in a roughly cuboidal shape.

The cooking apparatus 1 may include a door 300 arranged to open and close a front opening of the outer housing 100 and the inner housing 200.

On the front side of the door 300, an input portion (not shown) may be arranged for inputting a signal for a user to control the cooking apparatus 1. The input portion (not shown) may include a display portion (not shown) that displays an image, or a touch portion (not shown) that is arranged to input a signal by touching an image.

The door 300 may include a transparent member 301 that is arranged to allow a user to observe the interior of the cooking room 201 when the door 300 is closed.

The cooking apparatus 1 may include a shelf 202 mounted inside the cooking room 201 and arranged for a user to position a cooking item. The shelf 202 may be removably disposed within the cooking room 201.

The cooking apparatus 1 may include a heating source that provides heat to the interior of the cooking room 201 so that the food item is cooked by the heat.

The heating wall may be arranged to provide heat to the food item on which the shelf 202 is located so that the food item can be cooked. Additionally, the food item may be located at the bottom of the cooking room 201 without the shelf 202. In this case, the heating source may also provide heat to the cookware located at the bottom.

The heating source may include a heater 400 disposed on a top surface of the cooking room 201. The heater 400 may radiate heat generated by itself and transfer heat directly to the food item.

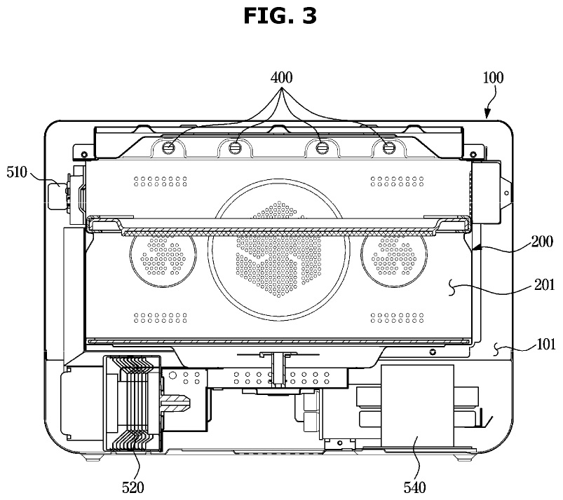

The heating source may include a magnetron (520 in FIG. 3), disposed on the underside of the cooking room 201. The high frequency generated by the magnetron 520 may be arranged to be injected into the interior of the food item to cook the interior of the food item by frictional heat between the molecules generated by repeatedly converting the molecular arrangement of the water contained in the food item.

The cooking apparatus 1 may include a heater 400 and a magnetron and may be arranged to efficiently cook a food item.

FIG. 3 is a cross-sectional view of the cooking apparatus 1 of FIG. 1 cut along a plane parallel to a front panel 110 of the outer housing 100.

As shown in FIG. 3, the cooking apparatus 1 may include a predetermined cooling space 101 formed between the inner housing 200 and the outer housing 100.

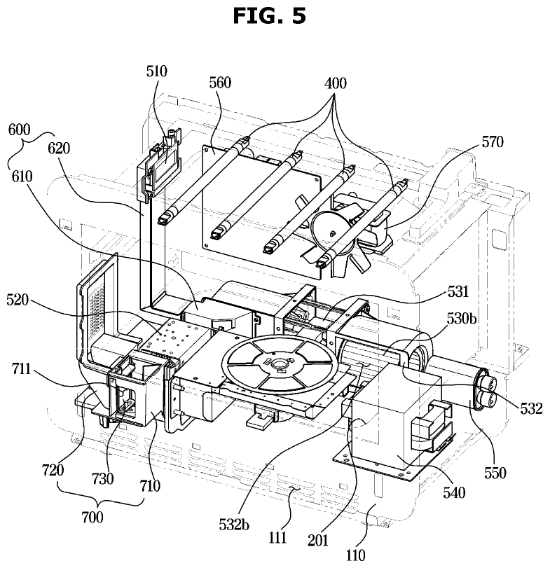

Various electronic components are located in the cooling space 101, and air may be flowed through the cooling space 101 by cooling fans (530a and 530b in FIG. 5) described below to cool the various electronic components.

Electronic components may generate heat. The electronic components may be divided by locations. Some of the electronic components may be located at an upper lateral side in the cooling space 101. For example, a lamp 510 that illuminates the interior of the cooking room 201 may be positioned at the upper lateral side in the cooling space 101.

Some of the electronic components may also be located on the lower side in the cooled space 101. For example, a heating source, i.e., a magnetron 520, a high voltage transformer (HVT) (540 in FIG. 5), a high voltage capacitor (HVC) (550 in FIG. 5), etc. may be located at the lower side in the cooling space 101.

Some of the electronic components located at the lower side in the cooling space 101 may be located at the lower left side in the cooling space 101, and others may be located at the lower right side in the cooling space 101.

The magnetron 520 may be located at the lower left side in the cooling space 101, and the HVT 540 and the HVC 550 may be located on the lower right side.

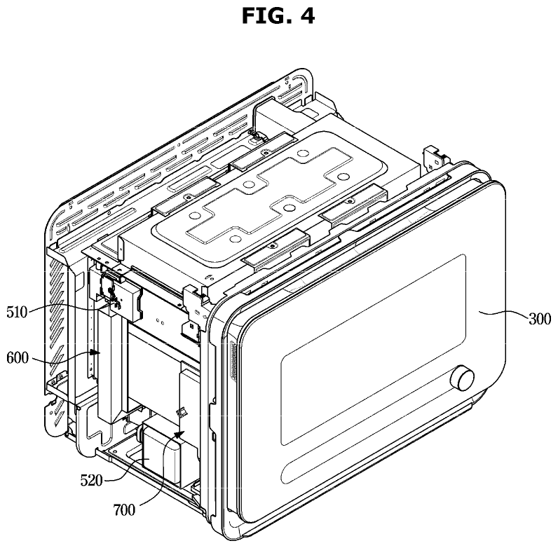

FIG. 4 is a perspective view with a portion of the outer housing 100 removed from the cooking apparatus 1 of FIG. 1, viewed from another side.

As shown in FIG. 4, the cooking apparatus 1 may include ducts 600 and 700 to guide air to cool the electronic components. The ducts 600 and 700 may be located between the outer housing 100 and the inner housing 200, i.e., in the cooling space 101. Since air is drawn into the cooling space 101 by the cooling fans 530a and 530b, the duct 600 and 700 may be positioned in the cooling space 101 to guide the drawn air. The ducts 600 and 700 may be coupled to an outer surface of the inner housing 200.

The ducts 600 and 700 may include a first duct 600 and a second duct 700. The first duct 600 and the second duct 700 may each guide air to a desired location. The first duct 600 may guide air toward the lamp 510. The second duct 700 may guide air into the cooking room 201. Specifically, the second duct 700 may guide air toward a transparent member 301 of the door 300 inside the cooking room 201.

In the present embodiment, the first duct 600 and the second duct 700 are coupled to the same side (the left side) of the inner housing 200. However, the first duct 600 and the second duct 700 may be coupled to different sides of the inner housing 200.

The first duct 600 may be positioned posterior to the second duct 700. However, the positions of the first duct 600 and the second duct 700 may be reversed, and are not limited thereto.

FIG. 5 is a perspective view of the cooking apparatus 1 of FIG. 1 with the outer housing 100 and inner housing 200 provided transparent to show the electronic components.

As shown in FIG. 5, electronic components, such as a printed circuit board (PCB) 560 and a motor 570 may be located on a rear surface of the cooling space 101. The PCB 560 and motor 570 may be cooled by air that is drawn in as the cooling fans 530a and 530b draw in outside air.

At a lower side of the rear surface of the cooling space 101, the cooling fan 530a and 530b, and a fan motor 531 for driving the cooling fan 530a and 530b may be located. The cooling fans 530a and 530b may be in plural, i.e., the cooling fans 530a and 530b may include a first cooling fan 530a on the left and a second cooling fan 530b on the right.

The cooling fans 530a and 530b may be located one on each side of the motor 570. The left cooling fan 530a may be located in the direction of the duct 600 and 700. The right cooling fan 530b may be located in the opposite direction of the ducts 600 and 700.

As described above, the left cooling fan 530b and the right cooling fan 530b are each located at the rear lower side of the cooling space 101 and may draw in air from outside the cooking apparatus and discharge it forward. The left cooling fan 530a and the right cooling fan 530b may be cross-flow fans.

Air discharged by the left cooling fan 530a may flow toward the ducts 600 and 700. The ducts 600 and 700 may guide the air discharged from the left cooling fan 530a. Air discharged from the right cooling fan 530b may cool the HVT 540, the HVC 550, and the like.

The cooling fan 530a and 530b and the fan motor 531 may be enclosed by a fan box 532. The fan box 532 may serve to protect the cooling fans 530a and 530b and the motor 570 from external impact. The first duct 600 may be coupled to the fan box 532. Since the cooling fan 530a is located inside the fan box 532, the fan box 532 may guide air discharged from the cooling fan 530a into the first duct 600.

On the front of the fan box 532, openings 532a and 532b may be formed to correspond to the cooling fans 530a and 530b. Air discharged from the left side cooling fan 530a may flow to the first duct 600 through the left side opening 532A.

The first duct 600 may include a first duct part 610 and a second duct part 620. The first duct part 610 may have an inlet positioned to face the cooling fan 530a such that air discharged from the cooling fan 530a may be drawn in. The second duct part 620 may be coupled to the first duct part 610, and may extend toward the first electronic component 510 to guide air toward the first electronic component 510.

A portion of the air guided by the first duct 600 travels toward the lamp 510. This allows the lamp 510 to be cooled. The remaining portion of the air guided by the first duct 600 is directed toward the magnetron 520 on the front side. This allows the magnetron 520 to be cooled.

The second duct 700 may be positioned in front of the first duct 600. Air exiting the first duct 600 may enter the second duct 700 after cooling the magnetron 520. Air entering the second duct 700 may be guided into the cooking room 201.

The second duct 700 may include a duct body 710 and a duct extending portion 720. The duct body 710 may be located in front of the first duct 600 and the magnetron 520. Thus, air exiting the first duct 600 may enter the duct body 710 after cooling the magnetron 520. One side of the duct extending portion 720 may be coupled to the duct body 710, and the other side of the duct extending portion 720 may extend to an upper side of the cooling space 101. The other side of the duct extending portion 720 may be coupled to a side surface of the cooking room 201. Air exiting the duct extending portion 720 may enter the cooking room 201.

The second duct 700 may include a damper 730. The damper 730 may be rotatably coupled to the duct body 710 of the second duct 700. The damper 730 may guide air flowing into the duct body 710 to the duct extending portion 720, or may prevent air from being directed to the duct extending portion 720. In other words, the damper 730 may allow or block air from flowing into the cooking room 201.

When air is blocked from flowing into the duct extending portion 720 by the damper 730, air may flow through an opening 711 of the duct body 710. A hole 111 is formed in the front panel 110 of the outer housing 100, and air that flows through the opening 711 of the duct body 710 may escape to the outside through the hole 111 of the front panel 110.

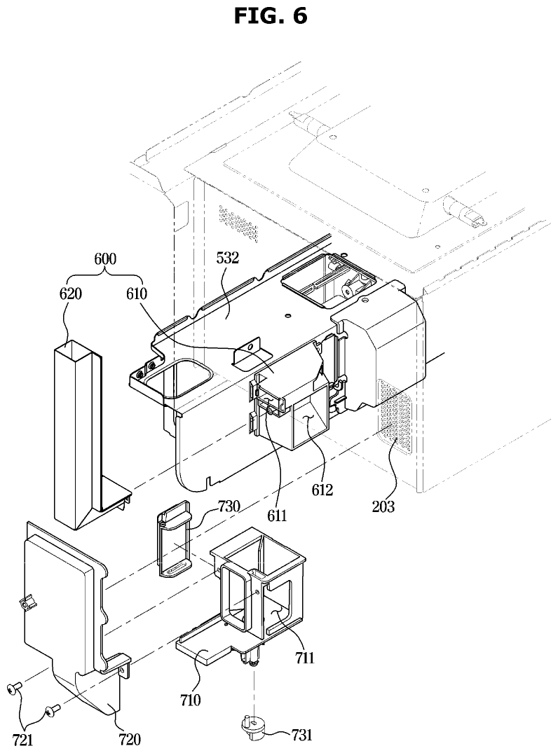

FIG. 6 is an exploded perspective view centered on the first duct 600 and the second duct 700 of the cooking apparatus 1 of FIG. 4.

As shown in FIG. 6, the first duct 600 may include the first duct part 610 and the second duct part 620, and the first duct part 610 may be coupled to the fan box 532.

The first duct part 610 may include a duct first area 611 and a duct second area 612. The duct first area 611 may guide a portion of the air introduced into the first duct part 610 toward the lamp 510. The duct second area 612 may be located adjacent to the duct first area 611 and may guide a portion of the air introduced into the first duct part 610 into the cooling space 101. As illustrated, the duct first area 611 may be located on an upper side of first duct part 610 and the duct second area 612 may be located on a lower side of the first duct part 610. However, it is not limited thereto.

Accordingly, a portion of the air entering the first duct part 610 is guided to the lamp 510 side by the duct first area 611, and the remaining air is guided to the cooling space 101 on the lower side by the duct second area 612.

Referring to FIG. 6, as described above, the second duct 700 may include the duct body 710 and the duct extending portion 720. The second duct 700 may further include the damper 730. The damper 730 may be rotatably coupled to the duct body 710. In this case, the opening and closing of the damper 730 may be regulated by a damper guide 731. The duct body 710 and the duct extending portion 720 may be connected by a coupling member 721. The duct extending portion 720 may be coupled to an outer surface of the inner housing 200, and may be connected to the cooking room 201 via a cooking room inlet 203.

The flow of air in the cooling space 101 is described below.

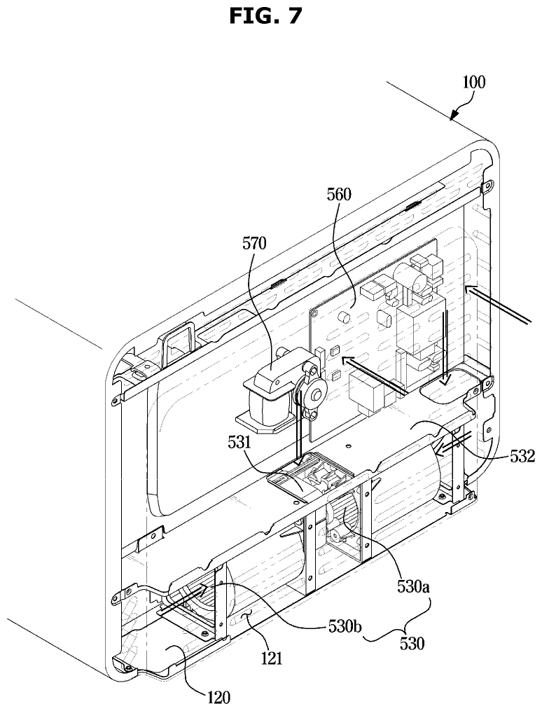

As shown in FIG. 7, when the cooling fans 530a and 530b are operated, air may be drawn into the cooling space 101 through a hole 121 in a back panel of the outer housing 100. The PCB 560 and the motor 570 may be located on the rear surface of the cooling space 101, and the PCB 560 and the motor 570 may be cooled as the outside air is drawn into the cooling fan 530 side.

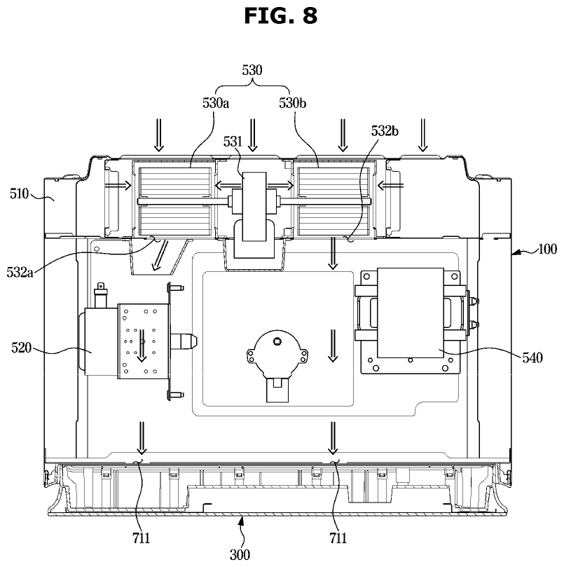

FIG. 8 is a schematic cross-sectional view of the cooking apparatus 1 of FIG. 1 from the top.

As shown in FIG. 8, the cooling fans 530a and 530b each discharge air forward and cool the electronic components located at the fronts thereof. In particular, the right cooling fan 530b may discharge air to cool the electronic components located at the front thereof, such as the HVT 540.

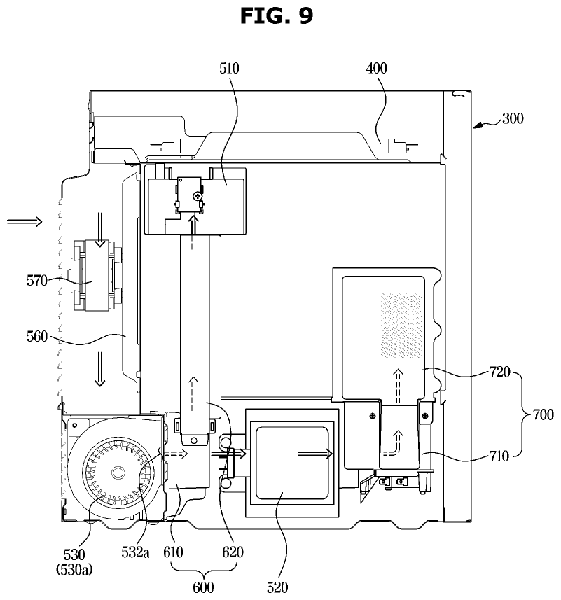

FIG. 9 is a schematic cross-sectional view of the cooking apparatus 1 of FIG. 1 from the left.

Air discharged by the left cooling fan 530a may flow into the first duct part 610 of the first duct 600. A portion of the air introduced into the first duct part 610 may be guided to the second duct part 620 by the duct first area 611 located on the upper side of the first duct part 610. The air guided to the second duct part 620 may flow by the second duct part 620 to the lamp 510 side located at the upper side in the cooling space 101. Thereby, the lamp 510 may be cooled.

The lamp 510 may be located adjacent to the heater 400 at the upper side in the cooled space 101, which may cause its temperature to rise to a high temperature, but may be effectively cooled due to the configuration of the first duct 600.

Furthermore, due to the above configuration of the first duct 600, a separate additional cooling fan for cooling the lamp 510 is unnecessary, which may have the effect of reducing costs and simplifying the assembly structure.

Air discharged forward of the first duct part 610 may flow toward the magnetron 520. The air discharged forward of the first duct part 610 may cool the magnetron 520. Air that has cooled the magnetron 520 may be directed to the duct body 710 of the second duct 700. Air entering the duct body 710 may be guided by the duct body 710 to the duct extending portion 720.

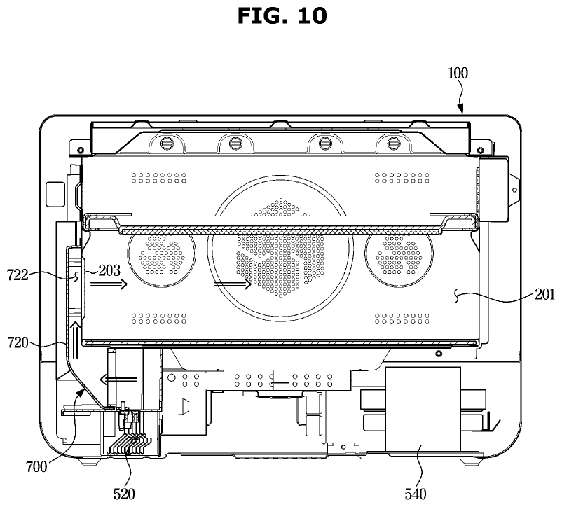

FIG. 10 is a schematic cross-sectional view of the cooking apparatus 1 of FIG. 1 from the front.

As shown in FIG. 10, air introduced into the duct body 710 of the second duct 700 may be guided upwardly through the duct extending portion 720. On the upper side of the duct extending portion 720, an outlet 722 may be provided, and a cooking room inlet 203 may be provided at a position corresponding to the position of the outlet 722. Air guided by the duct extending portion 720 may pass through the outlet 722 and the cooking room inlet 203 and enter the interior of the cooking room 201. Air introduced into the interior of the cooking room 210 may flow toward the transparent member 301 of the door 300.

When only the magnetron 520 of the cooking apparatus 1 is operating, the food inside the cooking room 201 is heated, but the cooking room 201 itself may not be heated. Hot water vapor is ejected from the heated food to the outside of the food, and this water vapor comes into contact with the transparent member 301 of the unheated door 300. At this time, the water vapor liquefies due to the temperature difference, and the transparent member 301 may become cloudy and foggy. Therefore, it may be difficult to clearly see the situation inside the cooking room 201 through the transparent member 301 of the door 300.

The air that flows out of the first duct 600 and passes through the magnetron 520 includes heat generated by the magnetron 520 and may have a temperature of about 90 degrees. This air flows through the second duct 700 to the transparent member 301 side of the door 300 inside the cooking room 201, and vaporizes water vapor on the transparent member 301.

Furthermore, since the temperature of the transparent member 301 of the door 300 is increased, the temperature difference between the transparent member 301 and the air adjacent to the transparent member 301 may be reduced and the phenomenon of water vapor liquefaction may be prevented. Thus, the situation inside the cooking room 201 may be clearly seen through the transparent member 301.

When the heater 400 is operated when the cooking apparatus 1 is in operation, the temperature in the cooking room 201 increases as well, making it less likely that frost will form on the door 300. Rather, when the heater 400 is operated, the temperature inside the cooking room 201 may be reduced by allowing air to flow past the magnetron 520. Thus, in this case, allowing air to flow into the cooking room 201 may actually decrease the efficiency of the cooking apparatus 1.

Accordingly, the cooking apparatus of the present invention may be configured to introduce air into the cooking room 201 through the second duct 700 when the heater 400 is not operating and only the magnetron 520 is operating, and to prevent air from being introduced into the cooking room 201 through the second duct 700 when the magnetron 520 is not operating and only the heater 400 is operating, or when the magnetron 520 and the heater 400 are operating together.

Furthermore, for this purpose, the cooking apparatus of the present invention includes a damper 730 that regulates a flow path inside the duct body 710. This will be described below.

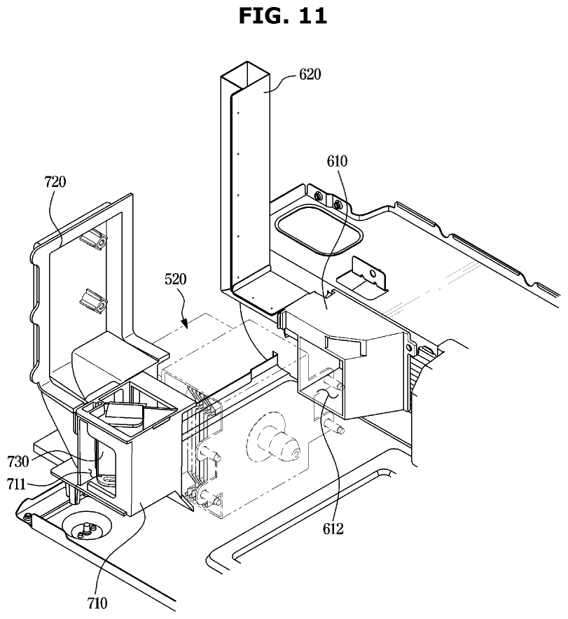

FIG. 11 is a perspective view centered on the first duct 600, second duct 700, and second electronic component 520 of FIG. 4.

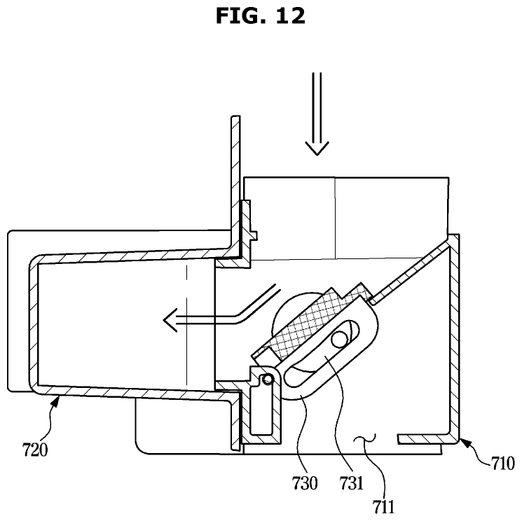

As shown in FIG. 11, a damper 730 is provided on the interior of the duct body 710. The damper 730 may be adjusted to allow air past the magnetron 520 to flow into the duct extending portion 720, or alternatively, to flow into the opening 711 formed in the front of the duct body 710. This will be described in more detail with reference to FIG. 12.

FIG. 12 is a top to bottom view of second duct 700, when damper 730 is open.

As shown in FIG. 12, air may flow into the duct extending portion 720 when the damper 730 is open, that is, when the damper 730 blocks the flow of air into the opening 711 formed in the front of the duct body 710 and guides the air into the duct extending portion 720. When the heater 400 is not operating, and only the magnetron 520 is operating, the flow of air may prevent water vapor from forming on the transparent member 301.

That is, when only the magnetron 520 is operating and the heater 400 is not operating, the damper 730 may be in an open state. When the damper 730 is in the open state, air is guided toward the duct extending portion 720, which may guide air toward the transparent member 301 of the door 300 inside the cooking room 201.

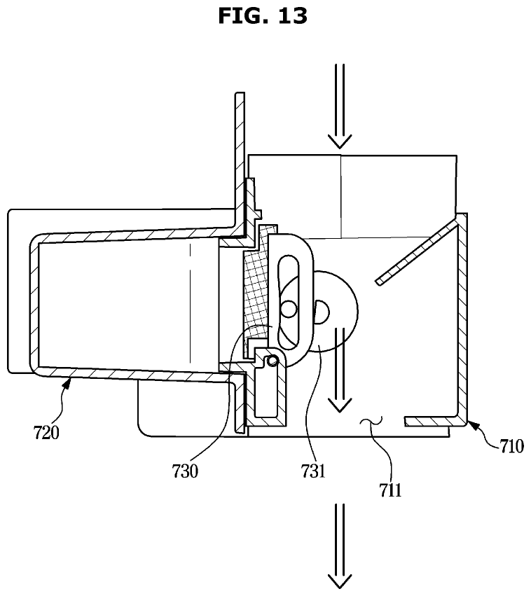

FIG. 13 is a top-to-bottom view of second duct 700, when damper 730 is closed.

As shown in FIG. 13, air may flow into the opening 711 formed in the front of the duct body 710 when the damper 730 is closed, that is, when the damper 730 prevents the flow of air into the duct extending portion 720 and guides the air into the opening 711 formed in the front of the duct body 710. When the heater 400 is in operation, it is necessary that air is not guided into the duct extending portion 720 because air flowing inside the cooking room 201 may impair the efficiency of the cooking apparatus 1.

That is, when only the heater 400 is operating, the damper 730 may be in a closed state. When the damper 730 is in the closed state, air is guided to the opening 711 formed in the front of the duct body 710, so that the efficiency of the cooking apparatus 1 may be maintained.

The air flowing into the opening 711 formed in the front of the duct body 710 escapes to the outside of the cooking apparatus 1 through the hole 111 formed in the front panel 110 of the outer housing 100.

The following describes an appropriate area ratio of the duct first area 611 and the duct second area 612 of the first duct part 610 of the first duct 600.

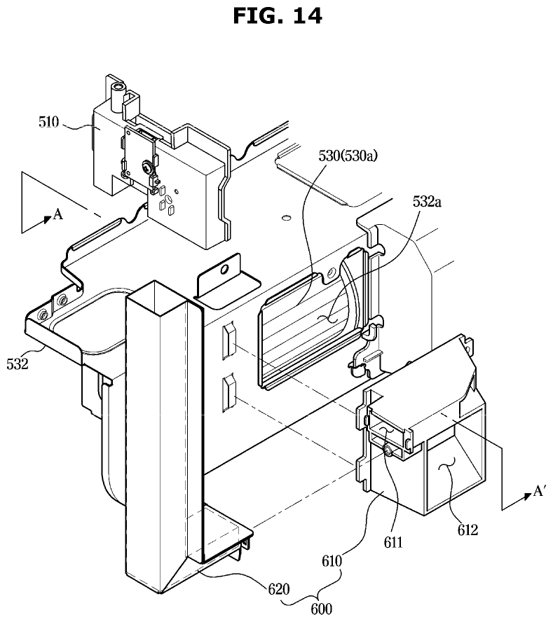

FIG. 14 is an exploded perspective view centered on the first duct 600 of the cooking apparatus 1 of FIG. 4.

As shown in FIG. 14, the first duct part 610 includes the duct first area 611 formed on its upper side and the duct second area 612 formed on its lower side.

Since the fan box 532 accommodating the cooling fan 530a and the first duct part 610 are coupled, air discharged by the cooling fan 530a may flow into the first duct part 610. The air discharged by the cooling fan 530a may be divided into the duct first area 611 and the duct second area 612 and may flow.

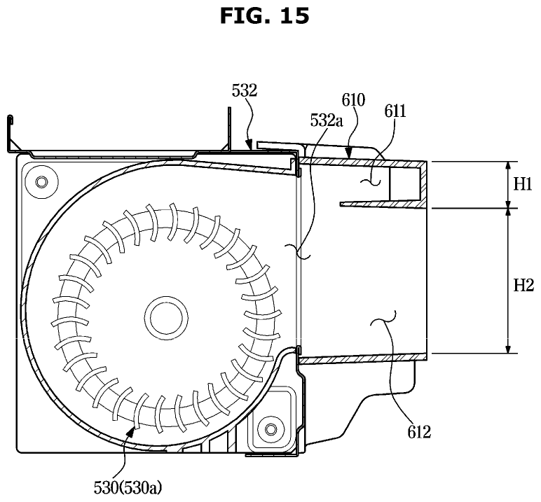

FIG. 15 is a cutaway cross-sectional view of AA′ centered on the first duct part 610 and cooling fans 530a and 530b of FIG. 11.

As shown in FIG. 15, the cross-sectional area ratio of the duct first area 611 and the duct second area 612 may be measured by the heights H1 and H2.

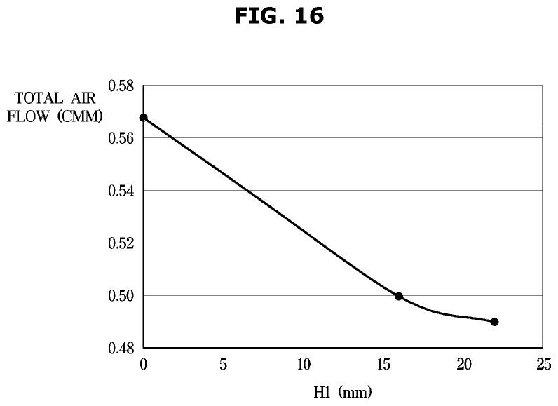

FIG. 16 is a graph showing the results of the experiment for H1 and H2.

As shown in FIG. 16, the experiments were labeled Before Change, Case 1, Case 2, and Final.

TABLE 1

| | Case 1 | Case 2 | Final |
|---|---|---|---|
| H1 (mm) | 22 | 16 | 11 |
| H2 (mm) | 34 | 40 | 45 |

TABLE 2

| | Before | | | |
|---|---|---|---|---|
| Q(CCM) | Change | Case 1 | Case 2 | Final |
| H1 | —. | 0.13 | 0.11 | 0.08 |
| H2 | —. | 0.35 | 0.39 | 0.43 |
| Total | 0.57 | 0.49 (14% | 0.50 (12% | 0.52 (11% |
| | | decrease) | decrease) | decrease) |

As shown in [Table 1], the heights of H1 and H2 were changed while keeping the overall height fixed at 56 mm. Before Change is obtained by conducting the experiment without dividing the area of the duct. In Case 1, the experiment was conducted with H1 of 22 mm and H2 of 34 mm. In Case 2, the experiment was conducted with H1 of 16 mm and H2 of 40 mm. In Final, the experiment was conducted with H1 of 11 mm and H2 of 45 mm.

As shown in [Table 2] of the experiments, Before Change resulted in a total airflow of 0.57 CCM. In Case 1, the total airflow was 0.49 CCCM, a 14% decrease in airflow from Before Change. In Case 2, the total airflow was 0.50 CCCM, a 12% decrease in airflow from before the change. In Final, the total airflow was 0.52 CCM, a 11% decrease from Before Change.

The flows to the duct first area 611 was 0.13 CCM for Case 1, 0.11 CCM for Case 2, and 0.08 CCM for Final.

As H1 increased, the total air volume tended to decrease. However, after a certain increase in H1, the amount of change in air volume decreased.

We found that 0.08 CCM of airflow to H1 was sufficient, and 0.43 CCM of airflow to H2 was needed to cool the magnetron.

Therefore, the ratio of H1 to H2 was appropriately 20 to 30:80 to 70, and more preferably 20:80.

Specific embodiments have been shown and described above. However, the present invention is not limited to the above embodiments, and one having ordinary skill in the art to which the invention belongs will be able to make various modifications without departing from the spirit of the technical idea of the invention set forth in the following claims.

What is claimed is:

1. A cooking apparatus comprising:
an inner housing forming a cooking room having a front that is open;
an outer housing on an outer side of the inner housing, with a cooling space being between the inner housing and the outer housing;
a door configured to open and close the open front of the cooking room;
a cooling fan in the cooling space at a lower rear side of the cooking room, the cooling fan configured to suction air from outside of the cooking apparatus and to discharge the suctioned air forward in the cooking apparatus;
a first duct configured to guide a portion of the air discharged by the cooling fan upward to cool a first electronic component in the cooling space and to guide a remaining portion of the air discharged by the cooling fan forward to cool a second electronic component disposed in the cooling space; and
a second duct configured to guide a portion of the air guided forward by the first duct into an interior of the cooking room.

2. The cooking apparatus according to claim 1, further comprising:
a heater on a top of the cooking room to heat the cooking room,
wherein the first electronic component is adjacent to the heater.

3. The cooking apparatus according to claim 1, wherein the first electronic component includes a lamp on an outer surface of the cooking room to illuminate the interior of the cooking room.

4. The cooking apparatus according to claim 1, wherein the second electronic component includes a magnetron configured to generate a high frequency to heat a cooking item placed in the cooking room.

5. The cooking apparatus according to claim 1, further comprising:
a fan box enclosing the cooling fan and configured to guide the air discharged by the cooling fan to the first duct.

6. The cooking apparatus according to claim 1, wherein the first duct includes:
a first duct part having an inlet facing the cooling fan so that the air discharged by the cooling fan is introduced into the first duct part through the inlet, and
a second duct part coupled to the first duct part and extending toward the first electronic component to guide air to the first electronic component.

7. The cooking apparatus according to claim 6, wherein the first duct part has:
a duct first area coupled to the second duct part, and configured to guide a portion of the air introduced into the first duct part to the first electronic component, and
a duct second area adjacent to the duct first area, and configured to guide a portion of the air introduced into the first duct part into the cooling space.

8. The cooking apparatus according to claim 7, wherein a cross-sectional area ratio of the duct first area and the duct second area is equal to 20˜30:80˜70.

9. The cooking apparatus according to claim 8, wherein
the second duct includes an outlet through which air guided by the second duct is released,
the outlet is coupled to a side of the inner housing, and
a cooking room inlet is on the side of the inner housing so as to be positioned to receive the air released through the outlet.

10. The cooking apparatus according to claim 8, wherein
the second duct includes a damper rotatably coupled inside the second duct, and
the damper is configured to allow or block air flow from the second duct into the cooking room.

11. The cooking apparatus according to claim 10, wherein
the cooking apparatus comprises a heater on a top of the cooking room to heat the cooking room,
the first electronic component includes a magnetron configured to generate a high frequency, and
the damper is configured to allow air from the second duct to flow into the interior of the cooking room when the heater is not operating and the magnetron is operating.

12. The cooking apparatus according to claim 8, wherein the second duct includes:
a duct body having an inlet at a front of the first duct so that air discharged by the first duct is introduced into the duct body through the inlet of the duct body, and
a duct extending portion coupled to the duct body, and extending upward toward the cooking room.

13. The cooking apparatus according to claim 10, wherein
the outer housing has a hole configured to allow air to escape through the hole when air flow from the second duct is blocked by the damper.

14. The cooking apparatus according to claim 8, wherein air outflowing from the first duct flows to the second electronic component and into the second duct.

15. The cooking apparatus according to claim 1, further comprising:
another cooling fan at a lateral side of the cooling fan in the cooling space at the lower rear side of the cooking room to cool a third electronic component,
wherein the cooling fan and the another cooling fan are driven by a single fan motor.
